(19) United States
(12) Patent Application Publication
(10) Pub. No.: US 2013/0323471 A1
(43) Pub. Date: Dec. 5, 2013

(54) ELECTRONIC APPARATUS INCLUDING GRIP PORTION

(71) Applicant: XACTI CORPORATION, Osaka (JP)

(72) Inventors: Yukiya Maeda, Shijonawate-shi (JP); Seiya Shibata, Hirakata-shi (JP)

(21) Appl. No.: 13/905,648

(22) Filed: May 30, 2013

(30) Foreign Application Priority Data
May 31, 2012 (JP) 2012-124626

(51) Int. Cl. B32B 3/30

(52) U.S. Cl. CPC B32B 3/30
USPC 428/166

(57) ABSTRACT

In an electronic apparatus including a grip portion according to the invention, a surface of the grip portion is covered by a surface layer member made of an elastic material, and a plurality of protrusions protecting toward the surface of the grip portion are formed on an inner surface of the surface layer member. The surface layer member includes a skin portion having an exposed surface, and the plurality of protrusions project from an inner surface of the skin portion. Tip ends of the protrusions abut against the surface of the grip portion, and a plurality of spaces are formed between the plurality of protrusions.

### CROSS-REFERENCE TO RELATED APPLICATION

This patent application claims priority to Japanese Patent Application No. 2012-124626. The entirely of Japanese Patent Application No. 2012-124626 is incorporated by reference herein.

### BACKGROUND OF THE INVENTION

1. Field of the Invention

The present invention relates to an electronic apparatus including a grip portion such as a digital camera and a video camera.

2. Description of Related Art

Conventionally, in an electronic apparatus of this kind, it is proposed to cover a surface of a grip portion provided on an end of an apparatus body with an exterior material made of various materials.

According to such an electronic apparatus, since an inner surface of a hand comes into contact with a surface of the exterior material in a state where the hand grips the grip portion of the apparatus body, a non-slip effect and a cushioning effect can be obtained.

In a conventional electronic apparatus in which a surface of a grip portion is covered by an exterior material, the exterior material is of a solid structure, and an elastic deformation amount is determined by a thickness and an elastic modulus thereof. Therefore, to secure a necessary elastic, deformation amount, it is necessary to employ a material having a small elastic modulus as the exterior material, and to form the exterior material thick.

However, since there is a limit in increasing a thickness of the exterior material, if a material having a small elastic modulus is employed, there is a problem that the entire exterior material becomes excessively soft and a grip feeling is deteriorated.

Hence, it is an object of the present invention to provide an electronic apparatus including a grip portion capable of obtaining a more excellent grip feeling than that of a conventional grip portion.

### SUMMARY OF THE INVENTION

According to an electronic apparatus of the present invention, a surface of a grip portion is covered by a surface layer member made of an elastic material, and a plurality of protrusions projecting toward the surface of the grip portion are formed on an inner surface of the surface layer member.

### BRIEF DESCRIPTION OF THE DRAWINGS

FIG. 1 is a perspective view of a digital camera according to an embodiment of the present invention;

FIG. 2 is a perspective view showing a state where a surface layer member is removed from the digital camera;

FIG. 3 is a perspective view showing a back surface side of the surface layer member;

FIG. 4A is a sectional view for explaining elastic deformation of the surface layer member;

FIG. 4B is a sectional view for explaining elastic deformation of the surface layer member;

FIG. 5 is a perspective view of a digital camera according to another embodiment of the present invention;

FIG. 6 is a perspective view showing a state where a surface layer member is removed from the digital camera;

FIG. 7 is a perspective view showing a back surface side of the surface layer member; and

FIG. 8 is a view showing another embodiment of the surface layer member.

### DETAILED DESCRIPTION OF THE PREFERRED EMBODIMENTS

Embodiments in which the present invention is applied to a digital camera will specifically be described with reference to the drawings.

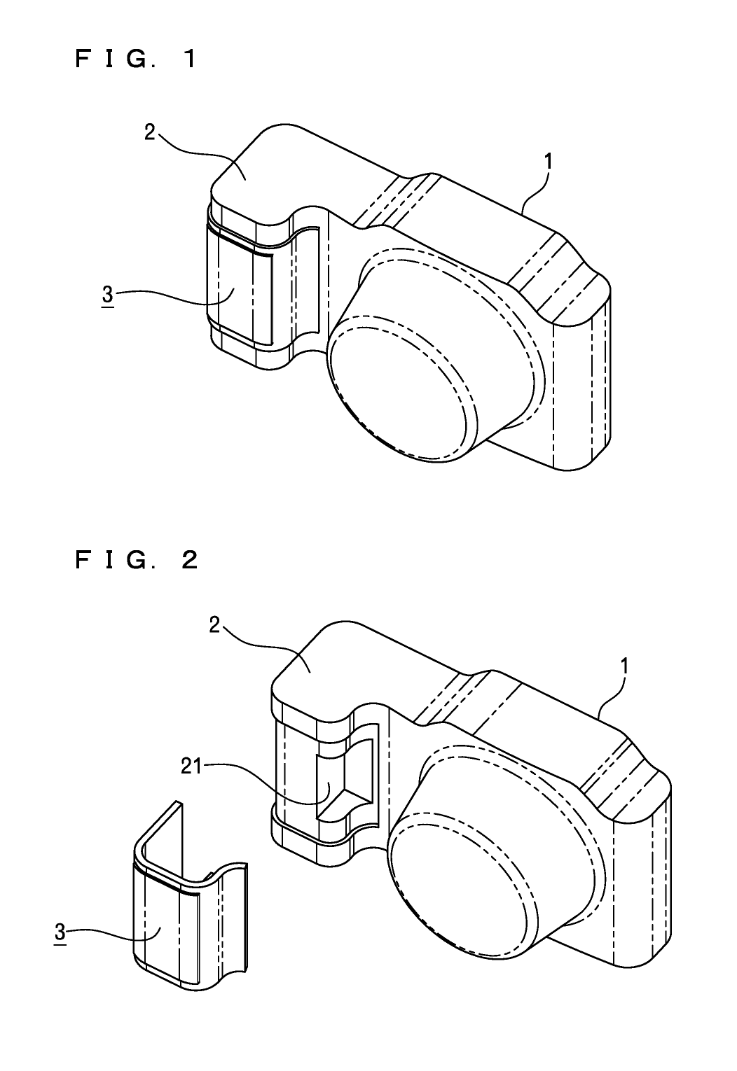

As shown in FIGS. 1 and 2, in a digital camera according to an embodiment of the present invention, an end of an apparatus body 1 is provided with a grip portion 2 having a shape suitable for being griped. By gripping the grip portion 2 with one hand, it is possible to hold the apparatus body 1 in a stable attitude.

A surface layer member 3 made of synthetic resin such as elastomer is adhered and fixed to a surface of the grip portion 2 of the apparatus body 1. The surface layer member 3 has a bent shape surrounding a substantially entire circumference of the grip portion 2 of the apparatus body 1.

Here, a recess 21 having a rectangular outline is formed in the grip portion 2 of the apparatus body 1 at a position corresponding to finger tips of a hand gripping the grip portion 2. The recess 21 is covered by an end of the surface layer member 3.

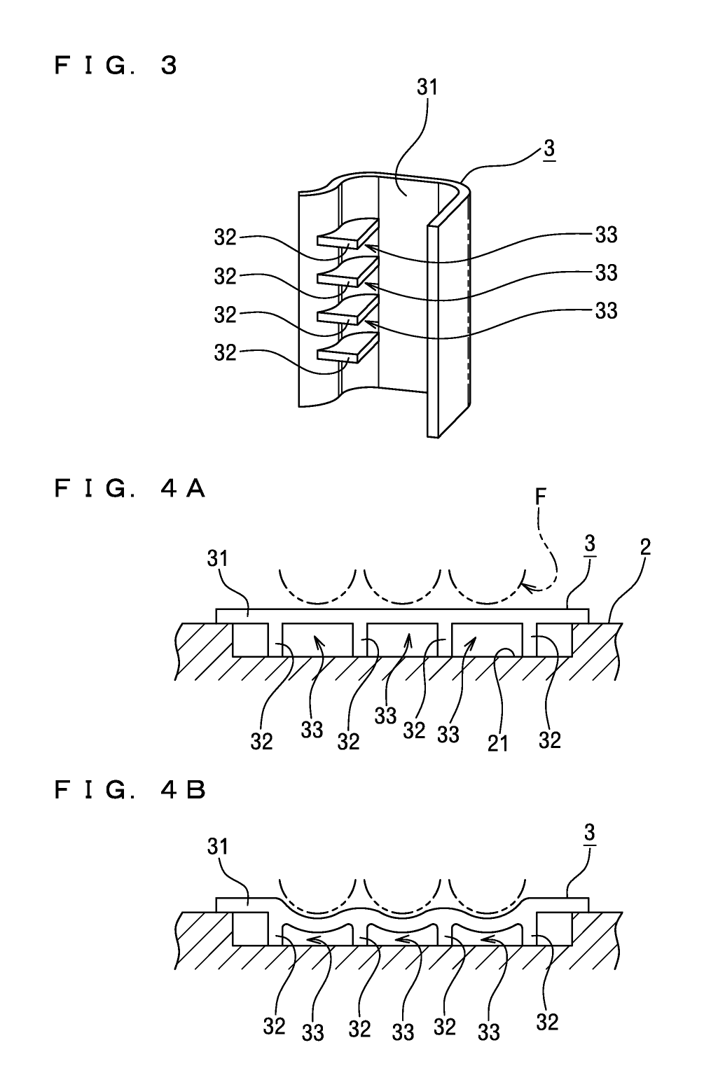

As shown in FIG. 3, the surface layer member 3 is configured by a skin portion 31 having a surface which is to be exposed and having a uniform thickness, and a plurality of protrusions 32 projecting from an inner surface region of the skin portion 31 which covers the recess 21 of the grip portion 2.

The plurality of protrusions 32 are formed in rib-shapes. The protrusions 32 extend in parallel in a lateral direction of the apparatus body 1 at a distance from one another. The distance between two adjacent protrusions 32, 32 is substantially equal to a thickness of one finger.

More specifically, the protrusions 32 extend along a plurality of fingers of the hand gripping the grip portion 2, and one of the fingers comes into contact with a region of the skin portion 31 which connects two adjacent protrusions 32, 32.

As shown in FIG. 4A, in a state where the surface layer member 3 is adhered and fixed to the surface of the grip portion 2, tip ends of the plurality of protrusions 32 of the surface layer member 3 abut against bottom surface of the recess 21 of the grip portion 2. A plurality of spaces 33 are formed between the protrusions 32.

Here, the skin portion 31 of the surface layer member 3 is supported by the surface of the grip portion 2 by the plurality of protrusions 32, and the skin portion 31 is stretched along the surface of the grip portion 2.

In this state, if a plurality of fingers F are put on the surface of the skin portion 31 of the surface layer member 3 to grip the grip portion 2, the surface of the surface layer member 3 is pressed by the inner surface of the hand, and the surface layer member 3 elastically deforms in a direction in which a thickness thereof is reduced.

As shown in FIG. 4B, in a region of the surface layer member 3 where the plurality of protrusions 32 are formed, the skin portion 31 which connects two adjacent protrusions 32, 32 is pressed by the finger tips and bends and deforms along the fingers. The plurality of protrusions 32 receive pressing forces from the finger tips, and are compressed and deformed in a direction in which heights thereof are reduced.

Therefore, bending deformation of the skin portion 31 and compressing deformation of the plurality of protrusions 32 are superimposed on the elastic deformation of the surface layer member 3. Especially, since a bending deformation amount of the skin portion 31 is relatively large, even when the surface layer member 3 is made of an elastomer having a relatively large elastic modulus, the surface layer member 3 sufficiently elastically deforms in accordance with gripping of the grip portion 2. Accordingly, an excellent grip feeling can be obtained, and the surface layer member 3 can be sufficiently held by the finger tips.

Moreover, as shown in FIG. 4B, since the skin portion 31 of the surface layer member 3 bends and deforms into a corrugated shape in accordance with the shape of a plurality of fingers F of a hand gripping the grip portion 2, an excellent fit feeling can be obtained.

On the other hand, in a region of the surface layer member 3 where the plurality of protrusions 32 are not formed, although the surface layer member 3 is compressed and deformed in its thickness direction by elasticity exerted by the skin portion 31, the elastic deformation amount thereof is relatively small since the thickness of the skin portion 31 is relatively small. Therefore, if a palm of the hand comes into contact with this region, the grip portion 2 can be stably gripped.

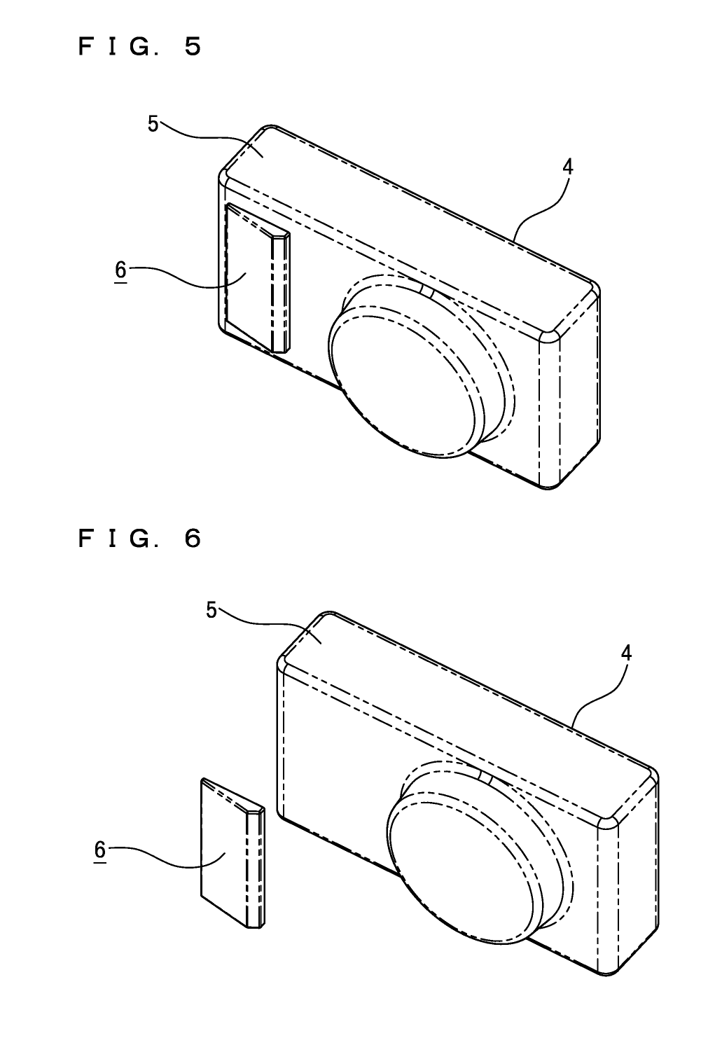

As shown in FIGS. 5 and 6, a digital camera according to another embodiment of the present invention includes a rectangular parallelepiped apparatus body 4, and an end of the apparatus body 4 can be gripped as a grip portion 2.

A surface layer member 6 made of synthetic resin such as elastomer is adhered and fixed to a front surface of a grip portion 5 of the apparatus body 4.

The surface layer member 6 has a substantially flat-plate shape, and a thickness thereof increases from the end of the apparatus body 4 toward a central portion of the apparatus body 4.

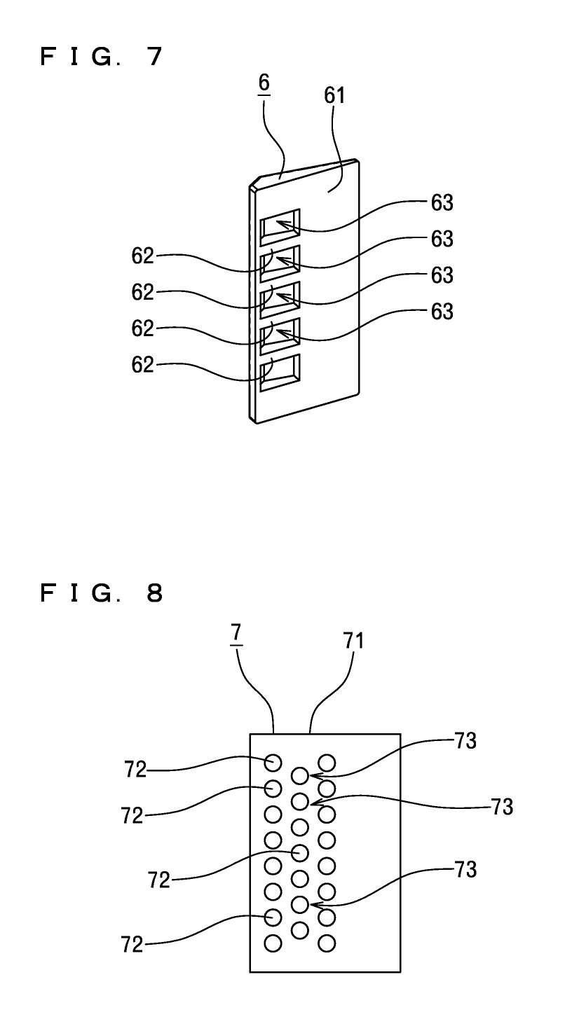

As shown in FIG. 7, in the surface layer member 6, a plurality of spaces 63 arranged in the vertical direction are recessed in an inner surface of a skin portion 61. Accordingly, a plurality of protrusions 62 are formed between the plurality of spaces 63.

Note that the plurality of spaces 63 are arranged with a pitch smaller than a thickness of one finger.

As shown in FIG. 5, in the digital camera to which the surface layer member 6 is adhered and fixed, if a plurality of fingers are put on the surface of the surface layer member 6 to grip the grip portion 5, the surface of the surface layer member 6 is pressed by the fingers, and the surface layer member 6 elastically deforms in a direction in which a thickness thereof is reduced.

In the region of the surface layer member 6 where the plurality of spaces 63 are formed, the skin portion 61 is pressed by the finger tips and bent and deformed, the plurality of protrusions 62 receive pressing forces from the finger tips, and the protrusions 62 are compressed and deformed in a direction in which heights thereof are reduced.

Therefore, bending deformation of the skin portion 61 and compressing deformation of the plurality of protrusions 62 are superimposed on the elastic deformation of the surface layer member 6. Especially, since a bending deformation amount of the skin portion 61 is relatively large, even when the surface layer member 6 is made of an elastomer having a relatively large elastic modulus, the surface layer member 6 sufficiently elastically deforms in accordance with gripping of the grip portion 5. Accordingly, an excellent grip feeling can be obtained, and the surface layer member can be sufficiently held by the finger tips.

On the other hand, in a region of the surface layer member 6 where the plurality of spaces 63 are not formed, although the surface layer member 6 is compressed and deformed in its thickness direction by elasticity exerted by the skin portion 61, the elastic deformation amount thereof is relatively small since the thickness of the skin portion 61 is relatively small. Therefore, if inner surfaces of fingers come into contact with this region, the grip portion 5 can be stably gripped.

FIG. 8 shows another surface layer member 7. In the surface layer member 7, a plurality of columnar protrusions 72 are arranged on an inner surface of a skin portion 71 at relatively high density. Accordingly, a plurality of spaces 73 are formed between the plurality of protrusions 72.

Also in a digital camera to which the surface layer member 7 is adhered and fixed, an excellent grip feeling can be similarly obtained.

Incidentally, the configuration of each of the constituent parts according to the present invention is not limited to those described preferred embodiment. Various changes can be made by those skilled in the art within the range not departing from the spirit of the present invention. For example, the present invention is not limited to the configuration in which the surface layer member is made of a single material, and the surface layer member can also be integrally formed by two-color molding using two kinds of elastomers having different elastic moduli, for example.

Furthermore, the present invention is not limited to the digital camera, and can also be applied to various electronic apparatuses such as a video camera.

What is claimed is:

1. An electronic apparatus comprising:
a grip portion; and
a surface layer member made of an elastic material to cover a surface of the grip portion, wherein
a plurality of protrusions projecting toward the surface of the grip portion are formed on an inner surface of the surface layer member.

2. The electronic apparatus according to claim 1, wherein the surface layer member includes a skin portion having an exposed surface, the plurality of protrusions project from an inner surface of the skin portion, tip ends of the protrusions abut against the surface of the grip portion, and a plurality of spaces are formed between the plurality of protrusions.

3. The electronic apparatus according to claim 1, wherein the surface layer member includes a skin portion having an exposed surface, a plurality of spaces are recessed in an inner surface of the skin portion, the plurality of protrusions are formed between the plurality of spaces, and tip ends of the protrusions abut against the surface of the grip portion.

4. The electronic apparatus according to claim 1, wherein the surface layer member includes a first region where the plurality of protrusions are disposed and a second region where the plurality of protrusions are not disposed, and a finger tip of a hand which grips the grip portion comes into contact with a surface of the first region.

5. The electronic apparatus according to claim 1, wherein each of the plurality of protrusions of the surface layer member is formed in a rib shape, the protrusions extend along a plurality of fingers of a hand which grips the grip portion, and one finger comes into contact with a skin portion region which connects two adjacent protrusions.
